(19) United States
(12) Patent Application Publication
(10) Pub. No.: US 2026/0350818 A1
(43) Pub. Date: Nov. 5, 2026

(54) Method and Device for Efficient Object Tracking and Correspondingly Configured Motor Vehicle

(71) Applicant: Bayerische Motoren Werke Aktiengesellschaft, Muenchen (DE)

(72) Inventors: Dominik KELLNER, Dachau (DE); Daniel MEISSNER, Friedberg (DE); Sascha STEYER, Pfaffenhofen a.d.llm (DE)

(21) Appl. No.: 19/118,508

(22) PCT Filed: Sep. 20, 2023
(86) PCT No.: PCT/EP2023/075887

§ 371 Date: Apr. 4, 2025

(30) Foreign Application Priority Data
Oct. 5, 2022 (DE) 10 2022 125 695.2

(51) Int. Cl. G06T 7/292; G06V 20/56

(52) U.S. Cl. CPC G06T 7/292; G06V 20/56

(57) ABSTRACT

An object-tracking device is configured to execute a method for object tracking. The movement status is determined for objects detected from sensor data of a sensor system. The objects are classified as moving or stationary. The object data, including characteristics and the movement status of the objects is stored. The object data of objects detected in a previous measuring cycle is updated based on the sensor data. For stationary objects, the characteristics stored in the object data are updated independently of one another.

### BACKGROUND AND SUMMARY

The present invention relates to a method for object tracking based on sensor data. The invention further relates to a corresponding device for the method and a motor vehicle equipped therewith.

In various technical applications and sectors—for example, but not exclusively, in the vehicle and transport sector—sensor-based detection and tracking, i.e. tracking of objects in a respective environment, can be useful, e.g. for avoiding collisions, for planning routes, for monitoring and/or the like. However, sensors and measurement methods used here, in particular combined with automatic object detection, are not always entirely exact and precise, which can be undesirable or even safety-relevant depending on the application concerned. An adaptive cruise control (ACC), for example, of a motor vehicle requires the most precise detection possible of a vehicle driving in front, and the most precise possible determination of its position. In particular, a distance between the driver's own vehicle and a vehicle ahead should not be overestimated if the vehicle ahead is currently stationary. The result of such an overestimation could be an unwanted automatic restart of the driver's own vehicle, which could in turn result in an understepping of a prescribed minimum distance or a collision.

One approach to extended object tracking by means of radar is described, for example, in DE 10 2020 123 585 A1. The method described there comprises creating one or more clusters based on received return points of a radar sensor of a vehicle. An estimated position and speed are then calculated in each case for these clusters. It is further determined whether the clusters are linked to an existing object track. According to the one or more clusters that are linked to the existing object track, the existing object track is then updated using at least the respective position of these one or more clusters.

For effective object tracking, a state of a respective object can typically be determined in any form. For this purpose, DE 10 2019 109 332 A1, for example, describes a method for determining an object state from a sequence of times. An occupancy grid is determined on the basis of sensor data, the grid providing evidence, for each of the multiplicity of cells, that the respective cell is free or is occupied by an object at a time. A subset of the cells which are associated with the object at the time is determined on this basis. Finally, the object state is determined for the time on the basis of an object state predicted for this time and on the basis of the determined subset of cells of the object. An object can thus be detected in a precise and robust manner and information relating to the object can be determined.

The object of the present invention is to enable particularly efficient sensor-based object tracking.

This object is achieved by the subject-matters of the independent patent claims. Further possible embodiments of the invention are disclosed in the dependent claims, the description and the figures. Advantages and possible embodiments which are presented in the description for one of the subject-matters of the independent claims are to be regarded at least analogously as features, advantages and possible embodiments of the respective subject-matter of the other independent claims and any possible combination of the subject-matters of the independent claims, possibly in conjunction with one or more of the dependent claims.

The method according to the invention can be applied to object tracking, i.e. to object tracking over a plurality of measurement cycles of a sensor system for environment and object detection. In particular, the method can be applied in a motor vehicle, but is not restricted to this specific application. In one method step of the method according to the invention, objects are detected in each case on the basis of sensor data captured in a measurement cycle of the sensor system. In other words, current sensor data from the sensor system can therefore be captured in each measurement cycle and can be evaluated or processed for object detection or object identification. The sensor system can comprise one or more individual sensors, wherein a plurality of such individual sensors of the sensor system can, in particular, be of different types. Sensor data from an individual sensor or from a plurality of sensors can therefore be captured in a measurement cycle, for example depending on measurement or recording frequencies or a synchronization of a plurality of individual sensors. The sensor system or the individual sensors that make up this system can themselves already detect and track objects internally. Corresponding objects that are detected and are tracked, i.e. managed, within the sensors can then be referred to as sensor objects. Sensor data provided by the sensor system can similarly be processed in order to detect objects outside the sensor system, for example by means of an object-tracking device configured to carry out or apply the method according to the invention or coupled to the sensor system, i.e., for example, a correspondingly configured control unit or assistance system or the like.

In a further method step of the method according to the invention, the movement state of detected objects is determined on the basis of the sensor data. Each object is categorized as a stationary object or a moving object. The movement state of an object can therefore indicate whether this object is moving or is stationary. A stationary object can, for example, be an object that has stopped moving, but in principle could move, or a stationary object which is by its very nature in a fixed location and/or at least in the context of the respective current application of the method has never yet been detected as moving. The movement states of the detected objects can be determined, for example, in relation to a predefined global coordinate system or in relation to the sensor system or a device equipped therewith, such as a motor vehicle or the like. In order to determine the movement state, the sensor data or data or quantities derived therefrom can be evaluated, for example in terms of at least one predefined criterion. A speed threshold value, for example, or a statistic relating to a plurality of detections of the respective object in consecutive measurement cycles and/or over a plurality of individual sensor detections assigned to the respective object, in particular from the respective current measurement cycle, can be evaluated. In the present context, such individual sensor detections can be individual data points or measurement points, i.e., for example, individual radar echoes or radar detections or lidar detections or lidar reflections and/or the like.

Object data which are associated with the object detected on the basis of the sensor data and which comprise a plurality of characteristics of the respective object and its determined movement state are further stored in the method according to the invention. The object data can therefore in each case be an object data set, also referred to as an object track, describing or characterizing the respective object. Objects detected in or represented by the sensor data can therefore be assigned in each case to such an object data set or object track, wherein the respective characteristics of the object are in each case stored or managed. The object data are therefore in each case object-specific, so that a corresponding object track is created or managed in each case for each detected object. The objects or their characteristics can thus be tracked or managed in the object data over a plurality of measurement cycles. A new object track can be created in each case for objects newly detected in the current measurement cycle for which no object track has yet been created or exists with characteristics determined on the basis of sensor data from at least one earlier measurement cycle.

The characteristics stored or indicated in the object data or object tracks can be or can indicate static characteristics and/or dynamic states or state data of the respective object. Static characteristics in this sense can be or can indicate, for example, a type of the respective object. Dynamic states or state data can be or can indicate data or quantities of the respective object that are at least potentially variable—for example from one measurement cycle to another—such as a position and/or a speed and/or an acceleration and/or a yaw angle and/or a yaw rate and/or the like. The object tracks can also be referred to as internal tracks, since they can be managed, for example, within the sensor system or within the sensor or within the object-tracking device close to the sensor along a corresponding signal or data processing pipeline. The movement state stored in the sensor objects or as part of the sensor objects and/or in the respective object data can be derived, for example, directly from the movement speed of the object and/or can be estimated by the sensor system or the respective individual sensor and/or can be determined or estimated—for example by the object-tracking device—from the sensor data or sensor objects or object data originating from the sensor system. Data or estimated movement states from a plurality of sensors—if available—can be combined. Depending on the sensor, the movement speed of an object can, for example, be directly measured or can be estimated from available sensor data, for example over a plurality of measurement cycles, i.e., for example, on the basis of a change in the sensor data over a plurality of measurement cycles.

A stationary object can be identified as such, for example directly from the respective movement state or object state, i.e. from the data or characteristics for an object, such as, for example, those determined by a sensor and/or on the basis of the sensor data originating from one or more sensors. An object can therefore be identified or categorized, for example, as a stationary object if a speed lying below a predefined speed threshold value is indicated in the complete object data for this object. A value of 0.5 m/s, for example, can be predefined as such a speed threshold value, wherein, however, other values can also be possible depending on the application or requirements. The complete object data can be understood here, for example, in contrast to individual sensor detections or raw sensor data assigned to the object. The object data can be or can comprise data or characteristics of the respective object determined or derived from such sensor detections or raw sensor data.

Depending on the design of the sensor system, the movement state of detected objects can already be determined or classified and/or at least some of the static and/or dynamic characteristics can be determined or estimated within the sensor or within the sensor system by one or more sensors that have detected a specific object. This can also be used, where appropriate, as a basis for categorizing objects as stationary objects or as moving objects. If the sensor system comprises a plurality of, in particular different, sensors, an object can be categorized, for example, as a stationary object or as a moving object if the movement states determined internally by a plurality of sensors for this object are correspondingly matching. This can enable a particularly fast and at the same time particularly reliable categorization. Furthermore, such a categorization can also be particularly flexible and robust, since, for example, the same sensors do not always have to be used. This can be particularly useful, for example, if an object is intermittently undetectable by a sensor, e.g. because it is hidden or the like.

In a further method step of the method according to the invention, the object data or at least the dynamic states contained therein and already detected in a preceding measurement cycle are in each case automatically updated on the basis of the current sensor data, i.e. the sensor data detected in the current measurement cycle. It can thus be ensured that current data or details relating to the respectively assigned object are stored in each case in the object data, i.e. the stored data in each case take account of the current measurement data or sensor data. The object data update provided here can be carried out at least for existing objects, i.e. objects already detected in one or more preceding measurement cycles. For objects newly contained in the current sensor data or detected anew, i.e. for the first time, a new object track can in each case be created, in which the current sensor data can then similarly be taken into account.

According to the invention, the characteristics stored in the object data are updated in each case independently from one another only for those objects that are categorized as stationary objects. In other words, the characteristics or at least the dynamic states or state data of a stationary object are decoupled from one another, i.e. are updated, for example, without cross-correlations or interactions of dependencies. This updating approach can also be referred to as a stationary update, since it is applied to stationary objects. If the stored characteristics comprise, for example, a position and a speed of the object, an updated position that has changed compared with the previous object data then has no effect on the determined or stored speed for a stationary object. Due to the independent updating of the characteristics, i.e. here, for example, the position and speed, a new position, for example, that has changed in comparison with the position previously stored in the object data according to the current sensor data does not therefore automatically result in a changed or non-zero speed of the respective object. The speed of an object categorized as stationary, for example, can therefore be held automatically at zero, unless, for example, an independent speed measurement indicates a speed of the respective object that is non-zero or exceeds a predefined threshold value. Any corresponding dynamic can therefore be prevented here for a stationary, i.e. motionless, object in the update.

This results in a correspondingly stable tracking of stationary, i.e. motionless, objects in terms of dynamic, i.e. potentially variable, characteristics. This represents an advantage of the method according to the invention over conventional approaches. Such conventional approaches often use data fusion methods that are applied to all detected objects for object tracking and updating of corresponding object data. In conventional approaches, no separate logics or data processing methods are therefore used for stationary and moving objects, but instead a comprehensive evaluation of the respective object and a correspondingly comprehensive processing of the corresponding sensor data or object data are carried out without adaptation to an actual physical or physically possible behavior of the respective physically real object. Thus, for example, a stationary vehicle cannot really change its orientation or build up a yaw rate as long as it is stationary. Furthermore, for an object that is stationary for the entire time, measurement uncertainties or variances in the sensor data, for example over a plurality of measurement cycles, indicate no real speed of the object.

Conventional approaches therefore fit, for example, all measurement points or sensor data for an object with a predefined model in order to ultimately determine, for example, a bounding box for the respective object and thus update the respective object data. If such bounding boxes or bounding frames are newly determined for an object in each measurement cycle, they are not always stable, i.e. not always constant, from one measurement cycle to another, even if the respective detected object is not actually moving. Nevertheless, in such cases, a movement—which does not really exist—of the respective object can then be erroneously detected. In the case of correspondingly high traffic density, for example, or in urban environments or the like, stationary measurement points can often occur in the immediate vicinity of a detected other vehicle, e.g. due to sensor detections assigned to the other vehicle which can actually originate from traffic infrastructure, such as the road surface or a curbstone or the like, or from an exhaust gas trail or the like. Measurement points or sensor detections of this type can be detectable or can be detected temporarily without movement of the other vehicle, i.e. the respectively detected object, and can be erroneously assigned to the respective object or can be integrated into the bounding box determined for this object. This can result in the erroneous detection of a speed or rotation or displacement, even for a stationary object. Such erroneous detections or erroneous estimations can in turn result in corresponding erroneous reactions of automated systems and can therefore potentially result in accidents or erratic behavior.

The present invention addresses these problems by treating sensor data and object data differently for objects categorized as stationary and for moving objects, wherein the update of the object data is carried out for stationary objects in such a way that erroneous detection of really non-existent movements or dynamics of stationary objects are thereby avoided or reduced.

Conversely, for the remaining, i.e. moving, objects, the update of the sensor data can be carried out in a different or conventional manner, e.g. based on sensor objects that are already being tracked by or in the sensor system and are output by the sensor system, and a filter-based fusion with the respective existing, i.e. previous, object data. A Kalman filter or the like, for example, can be used, dependencies or cross-correlations between different characteristics of the respective object can be taken into account and/or the like. However, a different data filter or fusion mechanism can similarly be applied, particularly if this effectively acts as a low-pass filter. Current sensor data and the data or characteristics of the respective object already stored in respective object data can be combined or fused with one another in a weighted manner by means of such a predefined filter or fusion mechanism. This can contribute to advantageously smooth and consistent tracking, particularly if detected objects move in a similar manner. The characteristics or at least the dynamic states or state data of detected objects not categorized as stationary can therefore be updated taking into account corresponding dependencies between the respective current sensor data or corresponding characteristics or quantities determined therefrom and previous object data. The fact that these characteristics or dynamic states of moving objects can actually change dynamically in a manner that is not precisely predictable, but nevertheless with a limited dynamic or rate, from one measurement cycle to another can therefore be taken into account.

The case can occur where the sensor system or at least a specific sensor, such as, for example, a camera used at least as part of the sensor system or the like, provides no detections or sensor data in a current measurement cycle for a specific object, in particular an object already detected in a previous measurement cycle. If this object was already categorized previously as a stationary object, the described update provided for stationary objects can then be carried out or applied for this object in the current measurement cycle also.

The method according to the invention can be combined or extended with further measures or method steps. The previous object data, for example, from objects already previously detected can initially be predicted or extrapolated according to a predefined model onto the current time, i.e., for example, the recording time of the sensor data of the current measurement cycle, before they are used as described.

In one possible embodiment of the present invention, the respective movement state of the detected objects is determined—at least for objects already categorized as stationary in a preceding measurement cycle or update cycle—on the basis of radar detections, i.e. radar data or radar echoes. Here, these radar detections can, in particular, be part of the respectively captured sensor data. An object is categorized as a stationary object if the speed of the respective object determined on the basis of radar, i.e. on the basis of the radar detections assigned to the respective object, is less in terms of amount than a predefined speed threshold value. Such a speed threshold value can, for example, be based on, i.e. can take account of, a respective measurement uncertainty of the radar sensor that is used. In other words, the radar detections, in particular a speed determined on the basis thereof, can be used here for a corresponding estimation of a motionless state.

This is based on the realization that radar detections, due to the direct measurement of the Doppler speed that is possible therewith, can be particularly well-suited to determining the movement state. A stable distance between the sensor system and the respective object can further be estimated on the basis of radar detections over one or more measurement cycles by means of a predefined robust estimation method that can be based, for example, on a median determination or histogram. This can avoid or reduce a potentially dangerous overestimation or underestimation of the distance, of the type that can occur, for example, with camera-based distance estimation. Functions based on the position and/or the speed and/or the distance of the respective object, such as, for example, automatic headway control or adaptive cruise control or the like, can be particularly safely and reliably implemented.

If the amount of the speed of the respective object determined on the basis of radar is less than the predefined speed threshold value, a corresponding flag, for example, can then be set automatically on a corresponding data processing, for example in the object data for the respective object, whereby the respective object is categorized or defined as a stationary object. Process noise can further be reduced for a stationary object in the respective signal processing or data processing. If the speed determined on the basis of radar for the respective object indicates a movement of this object in a measurement cycle, the process noise can conversely be automatically increased once more. In this way, a faster response can be achieved if the respective object starts to move, for example by means of the assistance system or functions using the object data as input.

In a further possible embodiment of the present invention, an object is in each case categorized as a stationary object if, in particular only if, at least a predefined number of measurements and/or at least a predefined proportion of a plurality of performed measurements produce or indicate a speed of the respective object lying below a or the predefined speed threshold value specified elsewhere. If the predefined number of measurements is used here as a criterion, a predefined minimum number of measurements on the basis of which this proportion is or has been determined can further be predefined for this criterion before it is used or evaluated as a criterion in respect of the categorization of the movement state of the respective object. In the embodiment of the present invention proposed here, the movement state of the respective object is determined in each case on the basis of a plurality of speed measurements rather than on the basis of a single speed measurement. The described dynamic can thus be prevented in the object data when they are updated for an object only if a plurality of Doppler measurements have indicated or confirmed a complete motionless state of the respective object over one or more measurement cycles for this object.

A corresponding criterion for categorizing an object as a stationary object can stipulate, for example, that at least five measurements which have been carried out consecutively or within a predefined time period produce or indicate a speed of the respective object lying below the predefined speed threshold value. The speed threshold value can, for example, be 0.1 m/s or 0.5 m/s or the like. However, other values can similarly be predefined depending on the application and requirement. In terms of the proportion of performed measurements as a criterion, it can be predefined, for example, that, out of all measurements or sensor detections for the respective object within a predefined time period or within a sliding time window of predefined length, at most 10% or at most 20% or at most 30% may indicate a speed lying above the speed threshold value in order to still categorize the object as a stationary object. Here also, the corresponding given proportion can be dependent on a respective application or on respective requirements, or can be sensor-specific. Overall, the embodiment of the present invention proposed here enables a particularly reliable and robust determination of the respective movement state of the detected objects and a correspondingly robust application of the method according to the invention.

In a further possible embodiment of the present invention, the object data of objects categorized as stationary are updated on the basis of individual sensor detections, whereas the object data of objects categorized as moving are updated on the basis of sensor objects output by the sensor system. Such sensor objects can be output, for example, in each measurement cycle, e.g. in the form of a list or the like, by the sensor system or by a respective sensor. Here, sensor objects are therefore objects that are tracked by the sensor system or by the respective sensor itself, i.e. internally detected over a plurality of measurement cycles also. The sensor objects can therefore be formed or reconstructed in each case by the sensor system or the respective sensor from a plurality of sensor detections. The sensor objects can comprise or indicate a plurality of characteristics of the respective underlying real object. The sensor objects can in each case indicate, for example, a bounding frame and/or a position and/or an alignment and/or a speed and/or a yaw rate and/or the like for the respective object as a whole, i.e. not only for the individual sensor detections assigned to the object.

The respective update can be carried out on the basis of such sensor objects for the objects categorized as moving by applying a predefined filter mechanism or fusion mechanism, which can also be referred to here as a complete update.

Conversely, a simplified update can be carried out for objects categorized as stationary. Along with at least one sensor detection assigned to the respective object, characteristics of the respective object already stored in the associated object data from one or more previous measurement cycles can also be used or taken into account. The individual sensor detections can be processed, where appropriate, more simply and/or more quickly, i.e. on the whole with less effort for updating the respective object data than for the sensor objects used only for updating the object data of the objects categorized as moving.

The sensor detections associated with an object categorized as stationary can be determined here based on the object data, i.e. the respective object track, in particular stored outside the respective sensor itself, in particular the dynamic state stored therein or the dynamic state of the respective object based thereon and predicted for the respective measurement time. This can be possible, in particular, because the position and location of a stationary object cannot, by definition, change and therefore sensor detections associated with the respective object can be selected from all available sensor detections by means of a predefined position-based or location-based criterion. As a result, sensor detections actually associated with a stationary object can be reliably and robustly selected and used for updating the respective object data. Since, in particular, the assignment of the sensor detections to a stationary object is not therefore performed here by the respective sensor itself, the probability of outliers, measurement errors, interference and/or drifting of the respective sensor resulting in incorrect assignments of sensor detections to the respective object or in an ultimately erroneous position update for the respective object is reduced.

Insofar as the sensor system comprises a plurality of different sensors, or sensor detections are carried out by different sensors for the respective object in the current measurement cycle, these sensor detections can be totally or only partially taken into account, i.e. used for the respective update. This can be dependent, for example, on detected deviations or inconsistencies between the sensor detections of different sensors, and on a predefined prioritization list for the different sensors. A prioritization list of this type can indicate which sensor is to be prioritized for stationary objects in general, or for assigning sensor detections to a stationary object or in each case for determining or updating a specific characteristic of a stationary object over other sensors or their sensor data. Both lidar detections and radar detections, for example, can be present as sensor detections for a stationary object, and/or the dynamic state stored in the already available object data, in particular the position of the respective stationary object based on older lidar detections. Since radar detections can be less suitable, i.e. can be given a lower priority, than radar detections for stationary objects, for example due to a tendency of radar sensors to drift, the radar detections to be assigned to the stationary object can be determined or selected, for example, on the basis of the position determined on the basis of lidar or on the basis of a bounding frame determined on the basis of lidar for the respective stationary object. This can be done, in particular, if lidar detections from the current measurement cycle remain consistent with a motionless state of the respective object at the known position already stored in the associated object data. At least some of the radar detections matching the current position of the respective stationary object can therefore be used, where appropriate, even in the event of drifting or inconsistencies in the radar detections. On the whole, the sensor detections assigned to the respective stationary object can be determined more precisely and more reliably, and, where appropriate, more sensor detections, i.e. more data for the respective update of the object data, can therefore be used or taken into account.

In a further possible embodiment of the present invention, a stable end detection is determined or selected in each case for objects categorized as stationary from all current sensor detections that have been or are currently assigned to the respective object in order to determine or define the current position of the respective object that is to be updated as a characteristic in the object data. This end detection can one of the sensor detections which is assigned to the respective object and which is used, i.e. interpreted or considered, as an end facing the sensor system—or, for example, a motor vehicle or the like equipped therewith—or as a corresponding side of the respective object. The sensor detections are assigned to the respective object according to a predefined criterion. This predefined criterion can be distance-based, particularly in relation to the previous position of the respective stationary object, i.e. the position already known or determined from an earlier measurement cycle and stored or indicated in the respective object data. In other words, the criterion can therefore query, for example, whether a specific sensor detection is located within a predefined distance in relation to the position of the respective stationary object indicated in the object data. Only in this case is the respective sensor detection then assigned to the respective stationary object. The determined or selected stable end detection can then be considered or used, for example over a plurality of measurement cycles, in a stable manner as the end of the respective object or as a reference for determining the position of the respective object.

The same sensor detection, i.e., for example, in each case a sensor detection originating from the same point of the respective object, can therefore be used as the stable end detection, for example for a stationary object over a plurality of measurement cycles or for as long as the respective object is categorized as or remains stationary. The end or the position of the respective object can then be determined as unchanged, i.e. stable, on the basis of this stable end detection. This is possible, in particular, even if, for example, other current sensor detections apparently indicate a different position of the respective object.

The stable end detection can similarly be determined, for example, as a median or mean value of the sensor detections assigned to the object and closest to the sensor system over a plurality of measurement cycles. The position of the stable end detection and therefore of the respective stationary object also can be kept or determined as stable even if all sensor detections assigned to the respective object are not detected as being constant, i.e. as having a stable position, over a plurality of measurement cycles.

Due to the design of the present invention proposed here, a stationary object can therefore be tracked and measured accordingly in a particularly reliable, precise and robust manner and can be responded to robustly, even in the case of consistent or fluctuating sensor detections.

In one possible development of the present invention, if the sensor detections assigned to the respective stationary object comprise radar detections, the stable end detection is determined or selected taking into account the corresponding radar cross sections (RCS). This can therefore be applied if the sensor system is or comprises a radar sensor. In particular, the radar detection closest to the sensor system, the radar cross section of which is greater than a predefined threshold value, can be determined as the end detection. This can be recorded, for example, particularly over a plurality of measurement cycles, in a histogram in which the radar cross section is plotted depending on the distance between the radar detections and the sensor system.

The probability of scatter or clutter detections in the vicinity of the respective object being taken into account to determine the position of the object, which could distort the position and location of the bounding frame for the respective object, can be reduced by taking account of the radar cross sections or the predefined threshold value for them.

The threshold value for the radar cross section can be predefined depending on an object type. Different threshold values for the radar cross section can therefore be taken into account for different types of objects. The method can thereby be applied robustly and reliably to different types of objects.

For a further improvement, it can be provided that a plurality or all radar detections assigned to the respective object are taken into account in each measurement cycle, i.e. are evaluated in terms of their radar cross section for determining or selecting the end detection. The position of the respective objects can ultimately be determined particularly reliably and robustly as a result. Since the radar detections can inherently also represent or comprise measurements or indications of the Doppler speed, the speed of the respective object can similarly be determined or estimated on the basis of these Doppler speeds according to the radar detections assigned to the object. The speed estimated in this way can then similarly be taken into account in the object data update, i.e., for example, can be recorded or fused therein.

In a further possible embodiment of the present invention, at least some of the characteristics stored or to be stored in the respective object data are determined on the basis of lidar detections at least for objects categorized as stationary. Here, the sensor system can therefore be or comprise a lidar sensor. The lidar detections are accordingly sensor detections of such a lidar sensor here. The lidar detections from the respective current measurement cycle are assigned here to the bounding frame for the respective object. A predefined position-based or location-based criterion, for example, can be evaluated for this assignment or association. Only those lidar detections, for example, which are located within a predefined area around the position of the respective object indicated in the object data can be assigned accordingly to the bounding frame. A corresponding distance, for example, and/or an angle range or distance range or the like can be predefined for this purpose. The distances between the lidar detections and the sensor system, for example, can similarly be determined and evaluated, for example as described elsewhere in connection with the radar detections.

A stable end detection which is used, i.e. considered or interpreted, as an end facing the sensor system—or a motor vehicle or the like equipped therewith—or a corresponding side of the respective object is determined here on the basis of a distribution, in particular a distance histogram, of these lidar detections assigned to the bounding frame of the respective object. The position, in particular, of the respective object is therefore determined as its characteristic. The position of the end detection or the end of the respective object thereby defined therefore serves here to define the position of the object as a corresponding characteristic of the object in the assigned object data. The lidar detections, sorted according to their distance—for example to the sensor system or to a different predefined reference point—can be plotted in the distance histogram, in particular over a plurality of measurement cycles.

The or a lidar detection which is located in the significant distance bin with or for the shortest distance or distance range can then be determined or selected as the end detection. In the present context, a distance bin of the distance histogram can be significant if a predefined threshold value is exceeded by it or therein. Such a threshold value can be predefined, for example, for the number of lidar detections in the distance bin or for an intensity, i.e. a corresponding reflectivity value, of the lidar detection or lidar detections in the distance bin. The position of a stationary object can be determined and tracked in a particularly stable, reliable and robust manner due to the design of the present invention proposed here. Functions based thereon can therefore be applied particularly reliably and intuitively, i.e., for example, without erratically appearing fluctuations or the like. This is possible due to the design of the present invention proposed here particularly if, for example, the same lidar detections are not detected, or lidar detections not always originating from the same points of the object are detected over a plurality of measurement cycles. The use of lidar detections proposed here can be particularly useful and effective for determining the position of stationary objects, since lidar sensors do not tend to drift, or at least tend to drift to a lesser extent than radar sensors.

In a further design of the present invention, dependencies between different characteristics of the respective object stored or indicated in the respective object data are cancelled in each case for objects categorized as stationary in order to update their object data. In other words, cross-correlations or links between different characteristics of the respective object can be deleted or removed or reset to zero here. This can comprise, for example, dependencies between the position and/or the speed and/or the acceleration and/or the yaw angle and/or the yaw rate of the respective object and/or the like. By canceling these dependencies, these characteristics are therefore decoupled from one another. As a result, for example, a change in the position of the respective object from the last measurement cycle or the last update of the position to the current measurement cycle for a stationary object does not automatically result in a corresponding speed or acceleration or a changed yaw angle or yaw rate being induced or being stored in the object data during the update.

Additionally or alternatively, a switch to a diagonal or diagonalized P-matrix is effected or such a matrix is used for objects categorized as stationary for modelling or management of the respective object in the associated object data. A P-matrix can indicate, for example, uncertainties of an object model or deviations from the object model or its predictions for the characteristics of the respective object. The use of a diagonal or diagonalized P-matrix prevents the development, as a result of the updating of one characteristic, of corresponding dependencies or cross-correlations or the like in relation to one or more other characteristics. This can be regarded, for example, in contrast to moving objects, in which a changed position or a specific or changed speed or a specific or changed acceleration is associated in each case with changes in the respective other values compared with the previous object data. A P-matrix, for example, with non-zero secondary diagonal elements can therefore be used for moving objects. Due to the design of the present invention proposed here, the independent updating of the characteristics of stationary objects can be achieved or implemented in a particularly simple, effective and reliable manner.

The invention also relates to an object-tracking device, which can be designed or configured, in particular, for a motor vehicle. The object-tracking device can therefore be designed, for example, as an assistance system for a motor vehicle or as part of such an assistance system. The object-tracking device according to the invention has an interface for capturing sensor data, and a data processing device for processing the captured sensor data. For this purpose, the object-tracking device, in particular its data processing device, can comprise, for example, a process device, i.e., for example, a microchip, microprocessor or microcontroller or the like, and a computer-readable data memory coupled thereto. A corresponding operating program or computer program which encodes or implements the method steps, measures or processes or corresponding control instructions described in connection with the method according to the invention can then be stored in this data memory. This operating program or computer program can then be executable by means of the process device in order to effect the execution of the corresponding method. The sensor data can be or can comprise, for example, raw data, sensor detections, sensor objects and/or the like. In particular, the object-tracking device according to the invention can be or can correspond to the object-tracking device or tracking device specified in connection with the method according to the invention. The object-tracking device according to the invention can be configured, in particular, to manage objects, i.e. object tracks for objects detected by the sensor system or represented in the captured sensor data. These object data can, for example, be stored or managed in the aforementioned data memory. The object-tracking device can provide the object data or make them retrievable or output them, for example, via the aforementioned interface or via a different interface, for example for a different assistance system.

The invention also relates to a motor vehicle, which has a sensor system for environment detection and an object-tracking device according to the invention coupled thereto. In particular, the motor vehicle according to the invention can be or can correspond to the motor vehicle specified in connection with the method according to the invention and/or in connection with the object-tracking device according to the invention. The motor vehicle according to the invention can accordingly have some or all of the characteristics or features specified in these connections. The motor vehicle according to the invention can have, for example, an assistance system for predefined driving assistance functions or for assisted or at least partially automated driving of the motor vehicle. This assistance system can then be configured to perform its function based on the object data managed by the object-tracking device according to the invention.

Further features of the invention are set out in the claims, the figures and the description of the figures. The features and feature combinations specified above in the description and the features and feature combinations shown below in the description of the figures and/or in the figures alone are usable not only in the respectively indicated combinations, but also in other combinations or in isolation without departing the scope of the invention.

### BRIEF DESCRIPTION OF THE DRAWINGS

FIG. 1 shows an example of a diagram to illustrate a method for sensor-based object tracking;

FIG. 2 shows a schematic representation to illustrate a radar-based object state estimation for the object tracking;

FIG. 3 shows an example of a histogram representation for further illustration of the object state estimation; and

FIG. 4 shows a schematic representation to illustrate a lidar-based object state estimation.

### DETAILED DESCRIPTION OF THE DRAWINGS

Identical or functionally identical elements are denoted with the same reference signs in the figures.

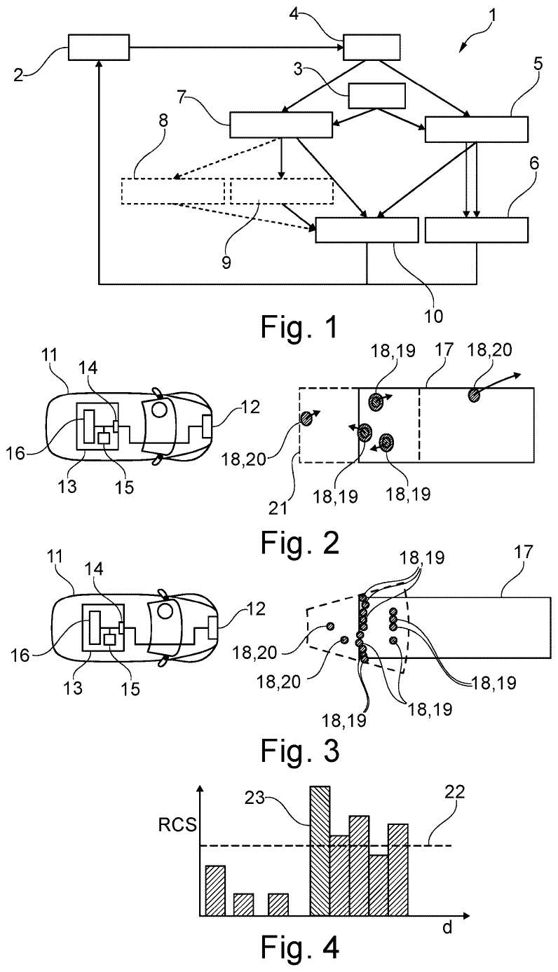

FIG. 1 shows an example of a method diagram 1 for a method for object tracking, of the type that can be applied, for example, in a vehicle for tracking objects in a respective environment. Characteristics of tracked objects are managed in object tracks 2, each of which is assigned in each case to a tracked object. Sensor data 3 are captured in each case in a measurement cycle or pass of the method. A prediction 4 of the object tracks 2 or the data stored therein or characteristics of the tracked, i.e. already known, objects can then initially be carried out for the current time or the recording time of the respectively captured sensor data 3. The object tracks 2 or the corresponding objects and also objects detected in or on the basis of the current sensor data 3 or indicated in the sensor data 3, which can also be referred to here as sensor objects, are then processed in an object association 5. The sensor objects from the current measurement cycle are in each case assigned, as far as possible, to one of the object tracks 2. This can be done, for example, based on an—if necessary abstract—predefined distance metric or the like. A new object track 2 can be created in each case, if necessary, for non-assignable sensor objects.

Environment objects categorized as moving on the basis of the object tracks 2 and/or the characteristics stored or indicated in the assigned sensor objects can then be further processed in a full update 6. The current sensor data 3 or sensor objects can be fused here in each case into the respectively assigned object track 2, in particular using a predefined filter mechanism, such as a Kalman filter or the like. The object tracks 2 are therefore updated, from which correspondingly updated object tracks 2 are then obtained as the starting point for the next measurement cycle or pass of the method.

The object tracks 2 relate in each case to a real object detected by sensors, the characteristics or state of which are/is estimated recursively over time in or by a recursive tracking algorithm. The object tracks 2 can also be referred to as internal tracks, and are stored in each case and updated in each case over a plurality of measurement cycles. In each such measurement cycle or frame, i.e. pass of the method, the sensor data can be captured by one or more sensors which indicate measurement data for sensor objects which are already being tracked within the respective sensor over time. Not only directly measured characteristics, such as a position and orientation, but also dynamic states, such as a speed or a yaw rate or the like, can be estimated here over time.

Each object 2 can also comprise an entry or a datum or data field here, for storing or indicating whether the respective object is moving or motionless, i.e. has stopped or is stationary.

The object tracks for stationary objects are managed or updated separately, i.e. differently from moving objects. For this purpose, individual sensor detections 18 (see FIG. 2, 4) rather than the sensor objects are assigned to the object tracks or to the objects managed therein in a corresponding detection association 7. For further explanation, FIG. 2 shows a schematic overview representing a motor vehicle 11, in which the method described here is applied. For this purpose, the motor vehicle 11 has a sensor system 12 here which can comprise, in particular, a radar sensor and/or a lidar sensor. The motor vehicle 11 further has an object-tracking device 13 which is coupled to the sensor system 12 via an interface 14 in order to carry out the method. The sensor data 3 supplied by the sensor system 12 can be processed by the object-tracking device 13, for example by means of a processor 15 and data memory 16 shown schematically here.

The motor vehicle 11 can scan its environment by means of the sensor system 12 and can detect objects there. Another vehicle 17 or corresponding bounding frame is indicated here schematically as such an object. A plurality of sensor detections 18 of the sensor system 12 are further indicated here. The sensor detections 18 comprise object detections 19 which actually originate from the other vehicle 17 and clutter detections 20 that do not originate from the other vehicle 17 and/or are due to measurement errors or interference. All sensor detections 18 located in a search area 21 assigned to the respective object, i.e. in this case the other vehicle 17, can then be determined from the current sensor data 3 for the detection association 7. Only sensor detections 18 located within the search area 21 are then considered for an assignment or association with the vehicle 17 of the corresponding bounding frame.

FIG. 3 shows a corresponding representation to illustrate a possible distribution of sensor detections 18 using a lidar sensor. If a lidar sensor is used, a larger number of stable object detections 19 can typically occur on the tailgate or on the end of the other vehicle 17 facing the sensor system 12 compared with the radar detections shown in FIG. 2. However, additional clutter detections 20 can occur. These can originate, for example, from an exhaust gas trail of the other vehicle 17 and/or inside the other vehicle 17 or the bounding frame for the other vehicle 17, for example due to windows or reflections of parts of an underbody of the other vehicle 17 or the like. A different shape of the search area 21 is shown here by way of example for the use of a lidar sensor.

Depending on the sensor that is used or is available, or on the type of the sensor detections 18, the sensor detections 18 can be assigned to the other vehicle 17, for example, based on a predefined distance criterion and/or a predefined cluster criterion and/or a predefined similarity criterion. The associated Doppler speed, for example, can thus be determined for each radar detection and can be compared with the speed stored in the object track 2 for the other vehicle 17. Only those radar or sensor detections 18 of which the Doppler speed deviates at most by a predefined amount from the speed stored in the associated object track 2 can then be assigned to the other vehicle 17. If, for example, a speed of 0 m/s is stored in the associated object track 2 and a deviation threshold value of, for example, at most 5 m/s is predefined for a stationary object, radar or sensor detections 18 of which the Doppler speed is, for example, correspondingly greater than 5 m/s can be rejected so that they are not therefore assigned to the other vehicle 17.

In the case where the sensor system 12 comprises a radar sensor or the sensor data 3 comprise radar detections, a motionless state estimation 8 can be carried out on the basis thereof for the respective object, i.e. in this case the other vehicle 17. The Doppler speeds of the sensor detections 18 are indicated in FIG. 2, by way of example, by corresponding arrows, the length of which correlates with the amount of the respective Doppler speed. A sensor detection located in the area of the bounding frame for the other vehicle 17, the Doppler speed of which is, however, much greater than the Doppler speeds of the remaining object detections 19, in particular greater than the or a predefined speed threshold value, can be categorized on that basis as a clutter detection 20. If the amount of the Doppler speeds of the object detections 19 or, for example, their mean value or median is less than the predefined speed threshold value which can take into account or map a measurement uncertainty of the radar sensor, it can be determined therefrom that the other vehicle 17 is motionless. A corresponding flag, for example, can then be set accordingly to indicate this motionless state. In particular, this motionless state flag can be set if the Doppler speeds of a plurality of radar detections, i.e., for example, of a predefined minimum number or predefined minimum proportion of the radar detections or object detections assigned to the respective object, are consistent with a motionless state of the respective object. If not, i.e., for example, if a corresponding predefined motionless state criterion is not satisfied, the flag cannot be set or reset or deleted.

A state estimation 9 can further be carried out on the basis of the object detections 19 assigned to the other vehicle 17. The corresponding radar detections can be evaluated, for example, in a histogram. Such a histogram is shown by way of example in FIG. 4. A distance d is plotted there on an x-axis, and the radar cross section RCS for the radar detections is plotted on a y-axis. In particular, radar detections occurring over a plurality of measurement cycles can be plotted cumulatively in the histogram. A significance threshold value 22 is further indicated here also. This can be predefined, for example, as a fixed value or as a proportion or percentage value of a maximum value of the radar cross section RCS in the histogram. A radar cross section RCS, for example, of 75% of the largest radar cross section RCS contained in the histogram can be determined as the significance threshold value 22. The shortest distance d or the first distance d viewed from a distance d=0 or distance bin at which or in which the significance threshold value 22 is exceeded can then be determined. This is characterized here as the first significance bin 23. The or a radar detection sorted there and assigned to the other vehicle 17 can then be determined from this first significance bin 23 as the stable end detection, or a virtual end detection, i.e. an end detection not necessarily corresponding to a real sensor detection 18, can be formed or calculated from these radar detections sorted in the first significance bin 23, e.g. through mean value formation or median formation or the like.

A histogram, in which, for example, the intensity or a reflectivity value of the lidar detections can be used instead of the radar cross section RCS, can also be constructed in a similar manner for lidar detections assigned to the other vehicle 17.

The stable end detection determined in this way on the basis of the object detections 19 can be used as a hold point for the respective other vehicle 17. This end detection or this hold point can therefore represent the other vehicle 17 or can be used to determine its current characteristics or object data, in particular the position or the distance d from the sensor system 12 or the motor vehicle 11.

The objects categorized as stationary or the corresponding object tracks 2 with the assigned current object detections 19 and/or the characteristics determined therefrom, such as the distance d or the corresponding position or the speed determined on the basis of radar or the like can then be fed to an update 10 or can be further processed in an update 10. Here, the update 10 therefore designates the method step for updating the object tracks 2 based on the current sensor data 3 for stationary objects. This update 10 for stationary objects can be carried out separately from the full update 6 for moving objects and can also differ therefrom.

All dependencies or cross-correlations between different data or characteristics, such as position, speed, acceleration, yaw angle, yaw rate and/or the like can be cancelled in the corresponding object tracks 2 for the update 10. The different characteristics or states of the respective object can therefore be decoupled from one another. A change, for example, in the position of the respective object in the x-direction, i.e., for example, along the vehicle longitudinal direction of the motor vehicle 11 does not then result in the introduction of a speed or acceleration of the object in the update 10. A change, for example, in the position of the respective object in the y-direction, i.e., for example, in or parallel to the vehicle transverse direction of the motor vehicle 11, similarly does not result in the introduction of a yaw rate or a modified yaw angle of the respective object. As long as the respective object is therefore categorized as stationary, i.e., for example, the corresponding flag is set, no movement or dynamic of the object is therefore introduced in the update 10 of the object tracks 2. The current, in particular dynamic, characteristics determined on the basis of the respective current object detections 19, for example, can be written to the respective object track 2 in the update 10. These characteristics can be determined or can have been determined, for example, on the basis of the stable end detection, i.e. the hold point, determined for the respective object.

Even if the respective object has just started to move, but the radar detections are still consistent with a motionless state of the object, the position can nevertheless be precisely and reliably updated here due to its independent updating. Even in such a situation, this enables, for example, a stable and precise maintenance of a specific distance d between the motor vehicle 11 and the respective object, i.e. in this case the other vehicle 17, for a corresponding assistance system.

Conversely, if the current radar detections indicate a non-zero speed of the other vehicle 17 that is no longer consistent with a motionless state, this speed can be written to the respective object track 2 in the update 10. The respective object is then therefore no longer categorized as a stationary object in the next measurement cycle or in the next pass of the method.

In the update 10 or in the state estimation 9 for stationary objects, only the individual characteristics, in particular, of the respective object can be determined and updated if necessary without estimating or determining, for example, a new bounding frame for the respective stationary object. An overall improved stability of the object tracking for stationary objects can thereby be achieved, e.g. compared with a handling or management of stationary objects in the same way as for moving objects with respectively complete re-determination of the respective bounding frame.

In the case where, for example, in a measurement cycle, the sensor system 12 or at least one sensor provides no sensor detection 18 or no object detection 19 for an object already previously detected, the detection association 7 cannot accordingly be carried out or cannot be carried out appropriately for this object in the current measurement cycle. The case can similarly occur where, under the current circumstances, the detection association 7 can be too elaborate for specific sensor detections, for example of a lidar sensor. However, the object association 5 can nevertheless then be carried out, if necessary, on the basis of the object track 2 already existing for the object. If this object is categorized as stationary, the update 10 can then be carried out for this object also. To do this, the movement state of the object can be transferred, for example, from the respective object track 2 or the object data stored therein, and/or a movement state determined for the object within the sensor by at least one sensor that has detected the object can be used.

The procedure described here for stationary objects, for example for the motionless state estimation 8 and/or for the update 10, can be applied in principle to any stationary objects. However, it can be particularly useful to apply the described method at least or only to an object directly ahead, i.e., for example, the closest vehicle ahead of the vehicle 11 viewed in its direction of travel. The vehicle, for example, which is located ahead, i.e. in front, of the motor vehicle 11, which has a similar orientation to the motor vehicle 11 and is located in the same traffic lane as the motor vehicle 11, can be used or regarded as this vehicle ahead. Such a vehicle ahead can be determined, for example, on the basis of the sensor data 3 and/or on the basis of road or traffic lane identification data and/or map data and/or data received via a Car2Car or Car2X data connection and/or the like. A precise knowledge and updating or tracking of the position and speed of such a vehicle ahead can be important, for example, for maintaining a predefined target distance between the motor vehicle 11 and the respective vehicle ahead as precisely as possible for safety reasons also. An adaptive cruise control or the like, for example, can therefore be more heavily reliant on a correspondingly precise tracking of the vehicle ahead than on a precise tracking of other objects that may be located, for example, at a greater distance and/or in a different traffic lane.

To summarize, it is possible, in the present method, to estimate whether or when a detected object is almost or completely motionless. When such a motionless state is detected, all characteristics or states of this object are then estimated separately. The position, for example, then has no effect on the speed. Radar detections in particular—insofar as available—can be used to detect the motionless state. Such radar detections can be particularly suitable for this purpose due to the direct measurement of the Doppler speed that is possible therewith. If, for example, a plurality of such Doppler measurements confirm a complete motionless state of the respective object over one or more measurement cycles, any dynamic, i.e. any dependencies between different characteristics or states, can be prevented in the associated object data. A stable distance d to the respective object can similarly be estimated on the basis of the radar detections and on the basis of lidar detections over one or more measurement cycles by means of a predefined, robust, for example histogram-based or median-based, estimation method. A particularly stable and robust tracking, even of stationary objects, can thus be enabled therewith. Corresponding data or characteristics can then be directly written to or fused with the respective object data. In this way, an overestimation or underestimation, for example, of the distance d to the respective object can be prevented or reduced compared with conventional approaches. A particularly stable tracking, even of stationary objects, is therefore enabled by the method described here, an apparent occurrence or detection of movements or rotations due to measurement uncertainties is prevented, and a precise and stable distance estimation or distance monitoring is enabled, even for previously stationary objects that have just started to move. This in turn enables a particularly reliable, robust and safe implementation of position-based or distance-based assistance functions.

On the whole, the described examples therefore show how an improved object state estimation can be implemented for stopped or stationary objects, in particular vehicles.

Reference sign list

| | |
|---|---|
| 1 | Method diagram |
| 2 | Object tracks |
| 3 | Sensor data |
| 4 | Prediction |
| 5 | Object association |
| 6 | Full update |
| 7 | Detection association |
| 8 | Motionless state estimation |
| 9 | State estimation |
| 10 | Update |
| 11 | Motor vehicle |
| 12 | Sensor system |
| 13 | Object-tracking device |
| 14 | Interface |
| 15 | Processor |
| 16 | Data memory |
| 17 | Other vehicle |
| 18 | Sensor detection |
| 19 | Object detection |
| 20 | Clutter detection |
| 21 | Search area |
| 22 | Significance threshold value |
| 23 | First significance bin |
| RCS | Radar cross section |
| d | Distance |

1-10. (canceled)

11. A method for object tracking over a plurality of measurement cycles of a sensor system, the method comprising:
detecting one or more objects based on sensor data captured in a measurement cycle of the sensor system;
determining a movement state of the detected objects based on the sensor data such that each object is categorized as a stationary object or a moving object;
storing, for each detected object, object data comprising: the determined movement state of the object and a plurality of characteristics of the object;
updating the object data of previously detected objects based on the sensor data, wherein the previously detected objects are objects detected in a preceding measurement cycle, wherein the characteristics of objects are updated in each case independently from one another only for objects categorized as stationary objects.

12. The method of claim 11, wherein the movement state is determined based on radar detections, wherein objects are categorized as stationary objects if the speed of the object determined on the basis of radar is less than a predefined speed threshold.

13. The method of claim 11, wherein objects are categorized as stationary objects only if at least a predefined number of measurements and/or at least a predefined proportion of a plurality of measurements indicate a speed of the object below a predefined speed threshold.

14. The method of claim 11 wherein the object data of stationary objects is updated based on individual sensor detections, and the object data of moving objects is updated on based on sensor objects output by the sensor system.

15. The method of claim 11, wherein a stable end detection is determined in each case for stationary objects from all current sensor detections that are assigned to the respective object according to a predefined distance-based criterion relating to the previous position of the respective object in order to determine the current position of the respective object that is to be updated as the characteristic in the object data.

16. The method of claim 15, wherein, where the sensor detections assigned to the respective object comprise radar detections, the stable end detection is determined taking into account its radar cross sections as the radar detection closest to the sensor system, the radar cross section of which is greater than a predefined threshold value.

17. The method of claim 11, wherein, for stationary objects, the position of the respective object is determined based on lidar detections, wherein lidar detections from the current measurement cycle are assigned to a bounding frame for the respective object, and a stable end detection is determined on the basis of a distance histogram of the lidar detections.

18. The method of claim 11, wherein, for updating the object data associated with stationary objects, dependencies between different characteristics of the respective object stored in the respective object data are cancelled and/or a switch to a diagonal P-matrix is carried out in order to model the respective object in the associated object data.

19. An object-tracking device for a motor vehicle, comprising:
an interface that captures sensor data; and
a data processing device configured to process captured sensor data,
wherein the object-tracking device is configured to carry out the method of claim 11.

20. A motor vehicle, comprising:
a sensor system for environment detection; and
an object-tracking device including:
an interface that captures sensor data; and
a data processing device configured to process captured sensor data,
wherein the object-tracking device is configured to carry out the method of claim 11.
